(19) United States
(12) Patent Application Publication
(10) Pub. No.: US 2003/0137970 A1
(43) Pub. Date: Jul. 24, 2003

(54) System and method for improved synchronization in a wireless network

(76) Inventor: Knut T. Odman, Vienna, VA (US)

Correspondence Address: XtremeSpectrum, Inc., Suite 700, 8133 Leesburg Pike, Vienna, VA, 22182, US

(21) Appl. No.: 10/347,751

(22) Filed: Jan. 22, 2003

Related U.S. Application Data
(60) Provisional application No. 60/349,354, filed on Jan. 22, 2002.

(51) Int. Cl. H04J 3/06

(52) U.S. Cl. 370/350

(57) ABSTRACT

A method is provided for synchronizing a network coordinator with a remote device in a wireless network. First the remote device sends a request to the network coordinator that includes request parameters. Then the network coordinator sends a reply to the remote device that includes reply parameters. These reply parameters include a part of the request parameters to identify the remote device. The remote device then sends an acknowledgement to the network coordinator to indicate successful receipt of the reply. Finally, the network coordinator sends a beacon to the remote device that includes beacon parameters. The beacon parameters include at least a portion of the reply parameters to identify the remote device. In an alternate implementation, the acknowledgement from the remote device can be replaced with a second request having second request parameters that include at least a portion of the reply parameters.

### CROSS-REFERENCE TO RELATED PATENT DOCUMENTS

This application relies for priority on U.S. provisional application Ser. No. 60/349,354, by Knut T. Odman, filed Jan. 22, 2002, entitled “GUARANTEED SYNCHRONIZATION OF FINITE STATE MACHINES IN DISTRIBUTED SYSTEMS FOR REQUEST-RESPONSE INTERACTIONS,” the contents of which is hereby incorporated by reference in its entirety.

### BACKGROUND OF THE INVENTION

The present invention relates to wireless personal area networks and wireless local area networks. More particularly, the present invention relates a system and method for improving synchronization in a wireless network.

The International Standards Organization's (ISO) Open Systems Interconnection (OSI) standard provides a seven-layered hierarchy between an end user and a physical device through which different systems can communicate. Each layer is responsible for different tasks, and the OSI standard specifies the interaction between layers, as well as between devices complying with the standard.

FIG. 1 shows the hierarchy of the seven-layered OSI standard. As seen in FIG. 1, the OSI standard 100 includes a physical layer 110, a data link layer 120, a network layer 130, a transport layer 140, a session layer 150, a presentation layer 160, and an application layer 170.

The physical (PHY) layer 110 conveys the bit stream through the network at the electrical, mechanical, functional, and procedural level. It provides the hardware means of sending and receiving data on a carrier. The data link layer 120 describes the representation of bits on the physical medium and the format of messages on the medium, sending blocks of data (such as frames) with proper synchronization. The networking layer 130 handles the routing and forwarding of the data to proper destinations, maintaining and terminating connections. The transport layer 140 manages the end-to-end control and error checking to ensure complete data transfer. The session layer 150 sets up, coordinates, and terminates conversations, exchanges, and dialogs between the applications at each end. The presentation layer 160 converts incoming and outgoing data from one presentation format to another. The application layer 170 is where communication partners are identified, quality of service is identified, user authentication and privacy are considered, and any constraints on data syntax are identified.

The IEEE 802 Committee has developed a three-layer architecture for local networks that roughly corresponds to the physical layer 110 and the data link layer 120 of the OSI standard 100. FIG. 2 shows the IEEE 802 standard 200.

As shown in FIG. 2, the IEEE 802 standard 200 includes a physical (PHY) layer 210, a media access control (MAC) layer 220, and a logical link control (LLC) layer 225. The PHY layer 210 operates essentially as the PHY layer 110 in the OSI standard 100. The MAC and LLC layers 220 and 225 share the functions of the data link layer 120 in the OSI standard 100. The LLC layer 225 places data into frames that can be communicated at the PHY layer 210; and the MAC layer 220 manages communication over the data link, sending data frames and receiving acknowledgement (ACK) frames. Together the MAC and LLC layers 220 and 225 are responsible for error checking as well as retransmission of frames that are not received and acknowledged.

FIG. 3 is a block diagram of a wireless network 300 that could use the IEEE 802 standard 200. In a preferred embodiment the network 300 is a wireless personal area network (WPAN), or piconet. However, it should be understood that the present invention also applies to other settings where bandwidth is to be shared among several users, such as, for example, wireless local area networks (WLAN), or any other appropriate wireless network.

When the term piconet is used, it refers to a network of devices connected in an ad hoc fashion, having one device act as a coordinator (i.e., it functions as a server) while the other devices (sometimes called stations) follow the time allocation instructions of the coordinator (i.e., they function as clients). The coordinator can be a designated device, or simply one of the devices chosen to function as a coordinator. One primary difference between the coordinator and non-coordinator devices is that the coordinator must be able to communicate with all of the devices in the network, while the various non-coordinator devices need not be able to communicate with all of the other non-coordinator devices.

As shown in FIG. 3, the network 300 includes a coordinator 310 and a plurality of non-coordinator devices 320. The coordinator 310 serves to control the operation of the network 300. As noted above, the system of coordinator 310 and non-coordinator devices 320 may be called a piconet, in which case the coordinator 310 may be referred to as a piconet coordinator (PNC). Each of the non-coordinator devices 320 must be connected to the coordinator 310 via primary wireless links 330, and may also be connected to one or more other non-coordinator devices 320 via secondary wireless links 340, also called peer-to-peer links.

In addition, although FIG. 3 shows bi-directional links between devices, they could also be unidirectional. In this case, each bi-directional link 330, 340 could be shown as two unidirectional links, the first going in one direction and the second going in the opposite direction.

In some embodiments the coordinator 310 may be the same sort of device as any of the non-coordinator devices 320, except with the additional functionality for coordinating the system, and the requirement that it communicate with every device 320 in the network 300. In other embodiments the coordinator 310 may be a separate designated control unit that does not function as one of the devices 320.

Through the course if the following disclosure the coordinator 310 will be considered to be a device just like the non-coordinator devices 320. However, alternate embodiments could use a dedicated coordinator 310. Furthermore, individual non-coordinator devices 320 could include the functional elements of a coordinator 310, but not use them, functioning as non-coordinator devices. This could be the case where any device is a potential coordinator 310, but only one actually serves that function in a given network.

Each device of the network 300 may be a different wireless device, for example, a digital still camera, a digital video camera, a personal data assistant (PDA), a digital music player, or other personal wireless device.

The various non-coordinator devices 320 are confined to a usable physical area 350, which is set based on the extent to which the coordinator 310 can successfully communicate with each of the non-coordinator devices 320. Any non-coordinator device 320 that is able to communicate with the coordinator 310 (and vice versa) is within the usable area 350 of the network 300. As noted, however, it is not necessary for every non-coordinator device 320 in the network 300 to communicate with every other non-coordinator device 320.

FIG. 4 is a block diagram of a device 310, 320 from the network 300 of FIG. 3. As shown in FIG. 4, each device (i.e., each coordinator 310 or non-coordinator device 320) includes a physical (PHY) layer 410, a media access control (MAC) layer 420, a set of upper layers 430, and a management entity 440.

The PHY layer 410 communicates with the rest of the network 300 via a primary or secondary wireless link 330 or 340. It generates and receives data in a transmittable data format and converts it to and from a format usable through the MAC layer 420.

The MAC layer 420 serves as an interface between the data formats required by the PHY layer 410 and those required by the upper layers 430.

The upper layers 430 include the functionality of the device 310, 320. These upper layers 430 may include TCP/IP, TCP, UDP, RTP, IP, LLC, or the like.

The management entity 440 provides monitoring and control functions to the MAC layer 420 and the PHY layer 410, and facilitates communication between the upper layers and the MAC layer 420. The management entity 440 may include a device management entity (DME) for controlling the operation of the device and a MAC layer management entity (MLME) for managing operation of the MAC layer 420. In alternate embodiments the DME can be called a station management entity (SME).

Typically, the coordinator 310 and the non-coordinator devices 320 in a WPAN share the same bandwidth. Accordingly, the coordinator 310 coordinates the sharing of that bandwidth. Standards have been developed to establish protocols for sharing bandwidth in a wireless personal area network (WPAN) setting. For example, the IEEE standard 802.15.3 provides a specification for the PHY layer 410 and the MAC layer 420 in such a setting where bandwidth is shared using a form of time division multiple access (TDMA). Using this standard, the MAC layer 420 defines frames and superframes through which the sharing of the bandwidth by the devices 310, 320 is managed by the coordinator 310 and/or the non-coordinator devices 320.

Device IDs and MAC Addresses

One important aspect of working with devices 310, 320 in a network 300 is uniquely identifying each of the devices 310, 320. There are several ways in which this can be accomplished.

Independent of any network it is in, each device 310, 320 has a unique MAC address that can be used to identify it. This MAC address is generally assigned to the device by the manufacturer such that no two devices 310, 320 have the same MAC address. One set of standards that is used in preferred embodiments of the present invention to govern MAC addresses can be found in IEEE Std. 802-1990, “IEEE Standards for Local and Metropolitan Area Networks: Overview and Architecture.”

For ease of operation, the network 300 can also assign a device ID to each device 310, 320 in the network 300 to use in addition its unique MAC address. In the preferred embodiments the MAC 420 uses ad hoc device IDs to identify devices 310, 320. These device IDs can be used, for example, to route packets within the network 300 based on the ad hoc device ID of the destination of the packet. The device IDs are generally much smaller than the MAC addresses for each device 310, 320. In the preferred embodiments the device IDs are 4-bits and the MAC addresses are 48-bits.

Each device 310, 320 should maintain mapping table that maps the correspondence between device IDs and MAC addresses. The table is filled in based on the device ID and MAC address information provided to the non-coordinator devices 320 by the coordinator 310. This allows each device 310, 320 to reference themselves and the other devices in the network 300 by either device ID or MAC address.

The present invention can be used with the IEEE 803.15.3 standard for high-rate WPANs, which is currently under development by the IEEE 802.15 WPAN™ Task Group 3 (TG3). The details of the current draft 802.15.3 standard, including archives of the 802.15.3 working group can be found at: http://www.ieee.802.orq/15/pub/TG3.html. Nothing in this disclosure should be considered to be incompatible with the draft 802.15.3 standard, as set forth on the IEEE 802 LAN/MAN Standards Committee web page.

Superframes

The available bandwidth in a given network 300 is split up in time by the coordinator 310 into a series of repeated superframes. These superframes define how the available transmission time is split up among various tasks. Individual frames of data are then transferred within these superframes in accordance with the timing set forth in the superframe.

FIG. 5 is a block diagram of a superframe according to preferred embodiments of the present invention. As shown in FIG. 5, each superframe 500 may include a beacon period 510, a contention access period (CAP) 520, and a contention free period (CFP) 530.

The beacon period 510 is set aside for the coordinator 310 to send a beacon frame out to the non-coordinator devices 320 in the network 300. Such a beacon frame will include information for organizing the operation of devices within the superframe. Each non-coordinator device 320 knows how to recognize a beacon 510 prior to joining the network 300, and uses the beacon 510 both to identify an existing network 300 and to coordinate communication within the network 300.

The CAP 520 is used to transmit commands or asynchronous data across the network. The CAP 520 may be eliminated in many embodiments and the system would then pass commands solely during the CFP 530.

The CFP 530 includes a plurality of time slots 540. These time slots 540 are assigned by the coordinator 310 to a single transmitting device 310, 320 and one or more receiving devices 310, 320 for transmission of information between them. Generally each time slot 540 is assigned to a specific transmitter-receiver pair, though in some cases a single transmitter will transmit to multiple receivers at the same time. Exemplary types of time slots are: management time slots (MTS) and guaranteed time slots (GTS).

An MTS is a time slot that is used for transmitting administrative information between the coordinator 310 and one of the non-coordinator devices 320. As such it must have the coordinator 310 be one member of the transmission pair. An MTS may be further defined as an uplink MTS (UMTS) if the coordinator 310 is the receiving device, or a downlink MTS (DMTS) if the coordinator 310 is the transmitting device.

A GTS is a time slot that is used for transmitting isochronous non-administrative data between devices 310, 320 in the network 300. This can include data transmitted between two non-coordinator devices 320, or non-administrative data transmitted between the coordinator 310 and a non-coordinator device 320.

As used in this application, a stream is a communication between a source device and one or more destination devices. The source and destination devices can be any devices 310, 320 in the network 300. For streams to multiple destinations, the destination devices can be all or some of the devices 310, 320 in the network 300.

In some embodiments the uplink MTS may be positioned at the front of the CFP 530 and the downlink MTS positioned at the end of the CFP 530 to give the coordinator 310 a chance to respond to an uplink MTS in the in the downlink MTS of the same superframe 500. However, it is not required that the coordinator 310 respond to a request in the same superframe 500. The coordinator 310 may instead respond in another downlink MTS assigned to that non-coordinator device 320 in a later superframe 500.

The superframe 500 is a fixed time construct that is repeated in time. The specific duration of the superframe 500 is described in the beacon 510. In fact, the beacon 510 generally includes information regarding how often the beacon 510 is repeated, which effectively corresponds to the duration of the superframe 500. The beacon 510 also contains information regarding the network 300, such as the identity of the transmitter and receiver of each time slot 540, and the identity of the coordinator 310.

The system clock for the network 300 is preferably synchronized through the generation and reception of the beacons 510. Each non-coordinator device 320 will store a synchronization point time upon successful reception of a valid beacon 510, and will then use this synchronization point time to adjust its own timing.

Although not shown in FIG. 5, there are preferably guard times interspersed between time slots 540 in a CFP 530. Guard times are used in TDMA systems to prevent two transmissions from overlapping in time because of inevitable errors in clock accuracies and differences in propagation times based on spatial positions.

In a WPAN, the propagation time will generally be insignificant compared to the clock accuracy. Thus the amount of guard time required is preferably based primarily on the clock accuracy and the duration since the previous synchronization event. Such a synchronizing event will generally occur when a non-coordinator device 320 successfully receives a beacon frame from the coordinator 310.

For simplicity, a single guard time value may be used for the entire superframe. The guard time will preferably be placed at the end of each beacon frame, GTS, and MTS.

The exact design of a superframe 500 can vary according to implementation. FIG. 6 shows an example of a specific superframe design. As shown in FIG. 6, the transmission scheme 600 involves dividing the available transmission time into a plurality of superframes 610. Each individual superframe 610 includes a beacon frame 620, an uplink MTS 630, a plurality of GTS 640, and a downlink MTS 660. This exemplary superframe includes no contention access period.

The beacon frame 620 indicates by association ID (known as a device ID in the IEEE 802.15.3 draft standard) a non-coordinator device 320 that is assigned to the current superframe 610. It also indicates via a receive-transmit table the transmitter/receiver assignments for the individual GTS 640.

In the exemplary superframe structure shown in FIG. 6, the uplink MTS 630 is set aside for the non-coordinator device 320 assigned to the current superframe 610 to upload signals to the coordinator 310. All other non-coordinator devices 320 remain silent on the current channel during this time slot. In alternate embodiments that use multiple channels, all other stations on that channel must remain silent during an uplink MTS 630, though they may still transmit on alternate channels.

The plurality of GTS 640 are the time slots set aside for each of the devices 310, 320 to allow communication between devices. They do so in accordance with the information set forth in the receive-transmit table in the beacon 620. Each GTS 640 is preferably large enough to transmit one or more data frames. When a transmitter-receiver set is assigned multiple GTS 640, they are preferably contiguous.

The downlink MTS 660 is set aside for the coordinator 310 to download signals to the non-coordinator device 320 assigned to the current superframe 610. All other non-coordinator devices 320 may ignore all transmissions during this time slot.

The lengths of the uplink and downlink MTS 630 and 660 must be chosen to handle the largest possible management frame, an immediate acknowledgement (ACK) frame, and the receiver-transmitter turnaround time. For the GTS 640, the length and number must be chosen to accommodate the specific requirements of frames to be transmitted, e.g., short MPEG frames, large frames of the maximum allowable length, and streaming vs. immediate ACK operation.

Although the disclosed embodiment uses a plurality of GTS 640, one uplink MTS 630 placed before the GTS 640, and one downlink MTS 660 placed after the GTS 640, the number, distribution, and placement of GTS 640 and MTS 630, 660 may be varied in alternate embodiments. Preferred embodiments of the present invention will be described below. And while the embodiments described herein will be in the context of a WPAN (or piconet), it should be understood that the present invention also applies to other settings where bandwidth is to be shared among several users, such as, for example, wireless local area networks (WLAN), or any other appropriate wireless network.

However, in sending messages between devices 310, 320 in a wireless network 300, it is necessary to make certain that all of the devices 310, 320 remain synchronized in the same operational states. Otherwise, communications could break down as each device 310, 320 no longer knows when and how it should communicate with other devices 310, 320. The present invention provides a system and method for synchronization between devices 310, 320 in a wireless network 300.

### SUMMARY OF THE INVENTION

Consistent with the title of this section, only a brief description of selected features of the present invention is now presented. A more complete description of the present invention is the subject of this entire document.

An object of the present invention is to improve the synchronization of a coordinator and remote device in a wireless network.

Another object of the present invention is to provide a method by which requests in a wireless network are processed such that they do not cause a network coordinator and a remote device to lose become out of synchronization.

These and other objects are accomplished by way of a method for synchronizing a network coordinator with a remote device in a wireless network, comprising: sending a request from the remote device to the network coordinator, the request including request parameters; sending a reply from the network coordinator to the remote device, the reply including reply parameters that respond to the request parameters; sending an acknowledgement from the remote device to the network coordinator, the acknowledgement indicating successful receipt of the reply; and sending a beacon from the network coordinator to the remote device, the beacon including beacon parameters, the beacon parameters including at least a portion of the reply parameters. The request may be an association request.

The request parameters preferably include a device identifier for the remote device, the device identifier distinguishing the network device from other devices. The device identifier is preferably a multiple-bit address assigned by a manufacturer to the remote device, which is unique among similar devices.

The reply parameters preferably include the device identifier for the remote device and a network identifier for the remote device, the network identifier being assigned by the network coordinator to distinguish the remote device from other network devices. The network identifier is preferably a multiple-bit association identifier that is unique within the network.

The network identifier is preferably smaller in size than the device identifier.

The beacon parameters may include the device identifier for the remote device and the network identifier for the remote device.

A method is also provided for synchronizing a network coordinator with a remote device in a wireless network. This method comprises: sending a first request from the remote device to the network coordinator, the first request including first request parameters; sending a reply from the network coordinator to the remote device, the reply including reply parameters that respond to the request parameters; sending a second request from the remote device to the network coordinator, the second request including second request parameters, the second request parameters including at least part of the reply parameters; and sending a beacon from the network coordinator to the remote device, the beacon including beacon parameters, the beacon parameters including at least a portion of the reply parameters. The first and second requests may be association requests.

The first request parameters preferably include a device identifier for the remote device, the device identifier distinguishing the network device from other devices. The device identifier is preferably a multiple-bit address assigned by a manufacturer to the remote device, which is unique among similar devices.

The reply parameters preferably include the device identifier for the remote device and a network identifier for the remote device, the network identifier being assigned by the network coordinator to distinguish the remote device from other network devices. The network identifier is preferably a multiple-bit association identifier that is unique within the network.

The second request parameters preferably include at least the device identifier for the remote device. The second request parameters also preferably include at least the network identifier for the remote device.

The network identifier is preferably smaller in size than the device identifier.

The beacon parameters preferably include the device identifier for the remote device and the network identifier for the remote device.

### BRIEF DESCRIPTION OF THE DRAWINGS

A more complete appreciation of the invention and its many attendant advantages will be readily obtained as it becomes better understood with reference to the following detailed description when considered in connection with the accompanying drawings, in which:

FIG. 1 is a diagram showing the hierarchy of the seven-layered OSI standard;

FIG. 2 is a diagram showing the hierarchy of the IEEE 802 standard;

FIG. 3 is a block diagram of a wireless network according to a preferred embodiment of the present invention;

FIG. 4 is a block diagram of a device from the network of FIG. 3;

FIG. 5 is a block diagram of a superframe according to preferred embodiments of the present invention;

FIG. 6 is a block diagram of a specific superframe design according to a preferred embodiment of the present invention;

FIG. 7 is a message sequence chart showing a request and synchronization process performed between a non-coordinating device and a coordinator, without contention according to a preferred embodiment of the present invention;

FIG. 8 is a block diagram showing two new associating devices trying to associate with an existing wireless network, according to a preferred embodiment of the present invention;

FIG. 9 is a message sequence chart showing a request and synchronization process performed between an associating device and a coordinator, with contention according to a first preferred embodiment of the present invention;

FIG. 10 is a message sequence chart showing a request and synchronization process performed between an associating device and a coordinator, with contention according to a second preferred embodiment of the present invention; and

FIG. 11 is a message sequence chart showing a typical asynchronous request between a non-coordinating device and a coordinator, according to a preferred embodiment of the present invention.

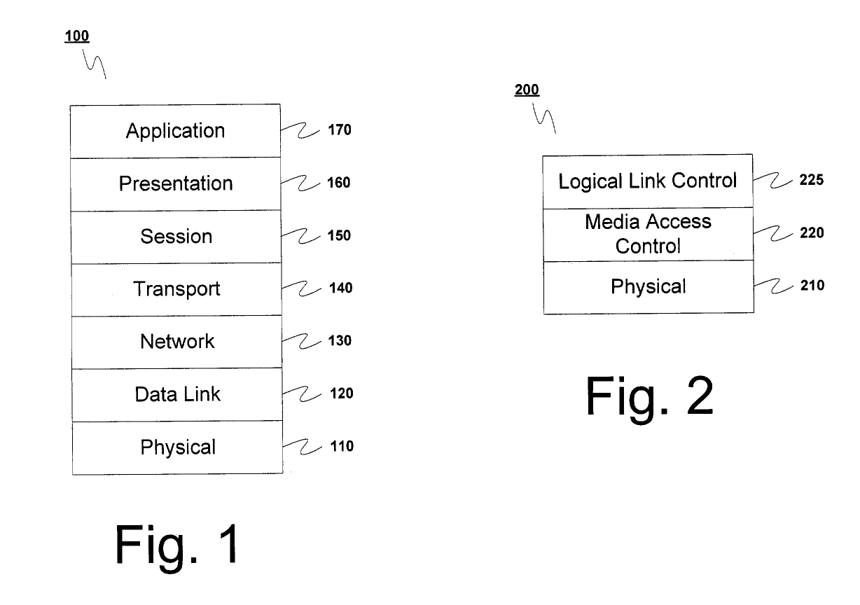

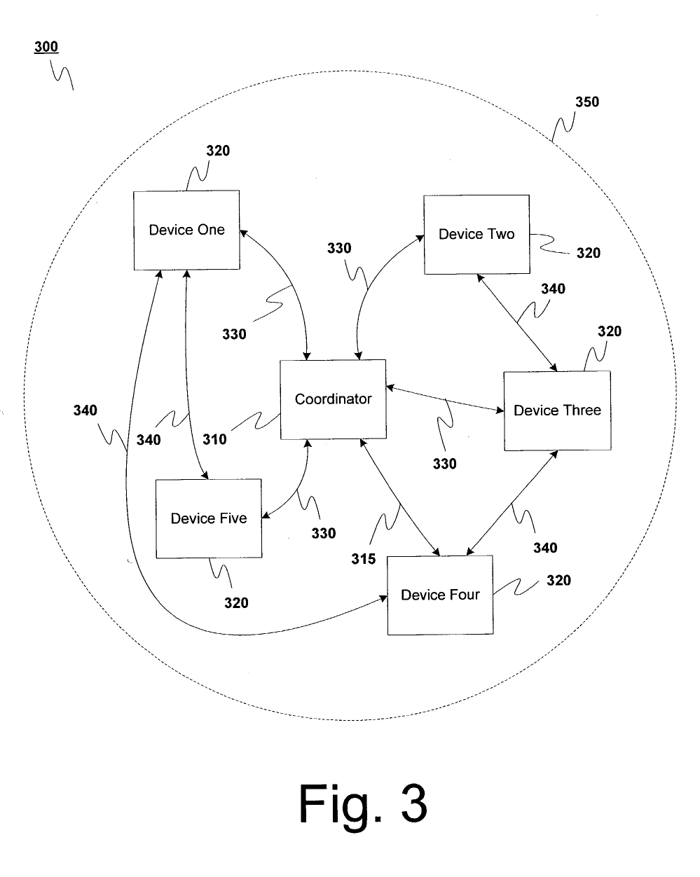

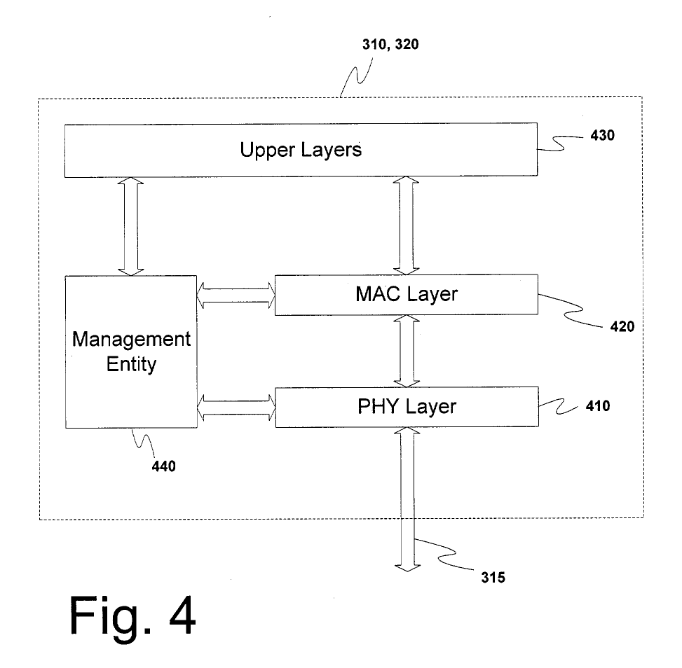

### DETAILED DESCRIPTION OF THE PREFERRED EMBODIMENTS

Preferred embodiments of the present invention will now be described with reference to the drawings. Throughout the several views, like reference numerals designate identical or corresponding parts.

A big problem in all distributed state machines (i.e., state machines that operate in more than one device) is keeping both devices synchronized in their proper states. Many protocols focus on increasing the probability of the successful delivery of a frame between devices, but pay too little attention to the even more important issue of keeping the client and server devices (e.g., a coordinator 310 and a non-coordinator 320) in agreement as to whether their interaction has succeeded or failed.

The present invention, as exemplified by its preferred embodiments, shows how improved synchronization can be achieved, both with and without contention. It also shows a procedure for handling asynchronous requests, when synchronization is not needed, but a guaranteed affirmative response should come within some reasonable time.

Contention Defined

Contention occurs when there is no unambiguous way to tell which device should send a transmission at a certain time. In such a situation, two or more devices may end up competing for the same media (i.e., the airwaves) at the same time.

The operation of the protocol can be significantly enhanced if the number of possible collision times is reduced to a minimum. In addition, the less contention occurs in the system, the more predictable traffic will be. This is because when there is no contention each device will always know the next available time that it can safely transmit.

Nevertheless, contention can generally only be predicted and reduced within a given network, or possibly among adjacent networks using the same media access protocol and radio spectrum. Additional mechanisms may be necessary to cope with interference from unrelated sources.

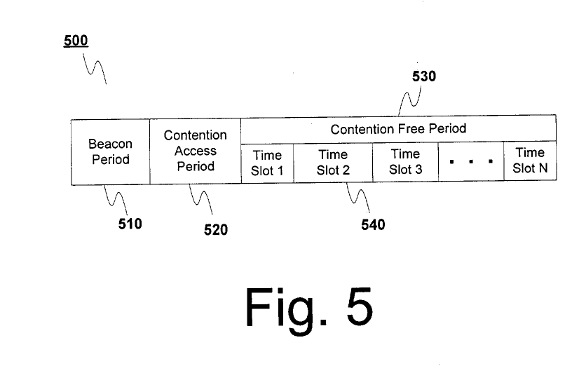

As shown in FIG. 5, one way to control contention is to set aside a contention access period (CAP) 520 in the superframe where all transmissions likely to cause contention will occur.

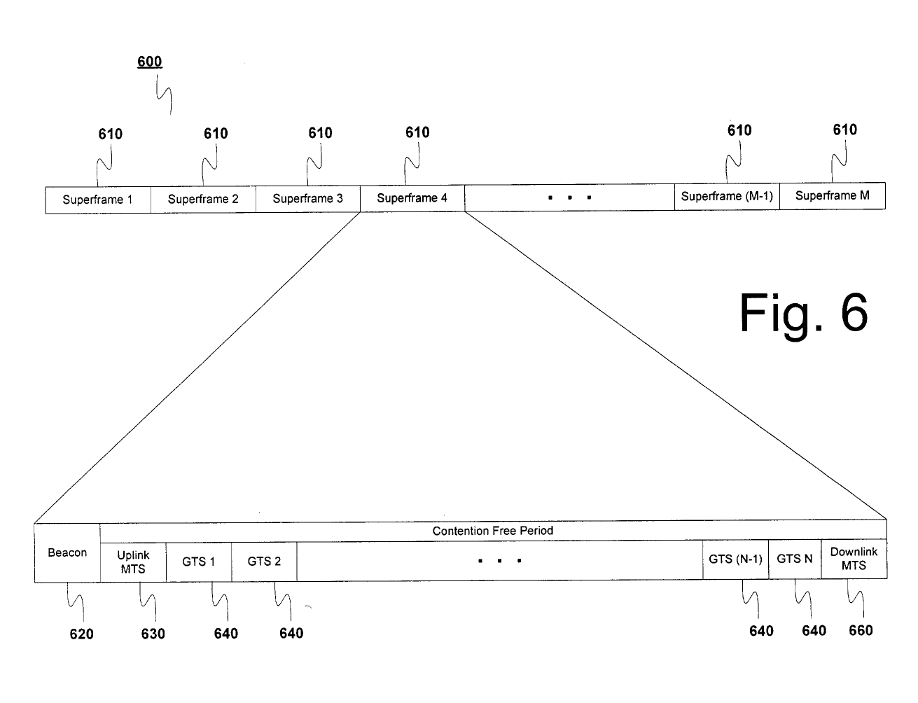

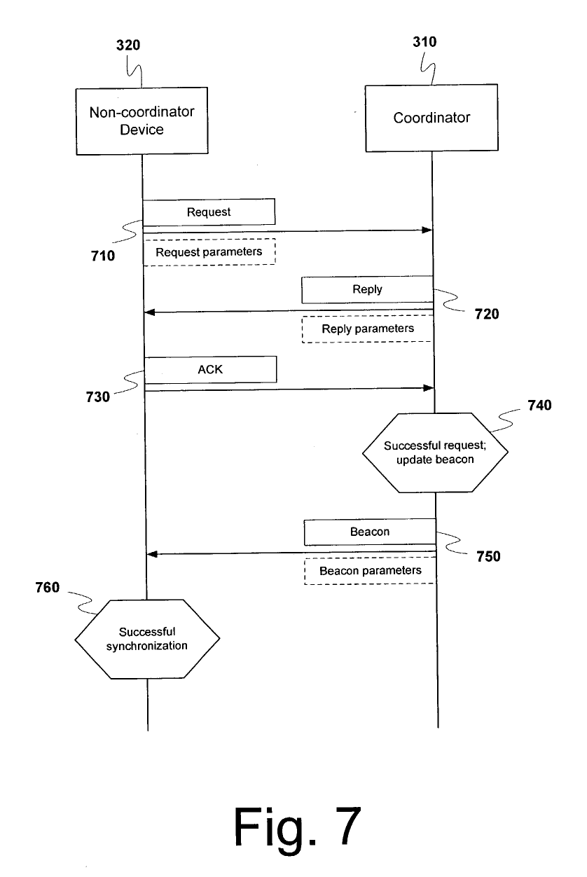

But, as shown in FIG. 6, in some alternate embodiments no CAP 520 is used. In this case, each superframe 710 includes one or more MTS that can be used for transmitting management information between the coordinator 310 and the non-coordinator devices 320. As noted above, the coordinator 310 preferably assigns the available MTS to the non-coordinator devices 320 in the network 300 in a fair distribution.

However, an MTS can only be assigned to non-coordinator device 320 when the particular device 320 is known to the coordinator 310. Preferably the coordinator 310 periodically sets aside one or more unassigned MTS for transmissions from unassigned devices, e.g., new devices requesting association. Since all association requests involve an unknown device, they cannot be done in an assigned MTS and must be done in an unassigned MTS with the possibility of contention, i.e., with the possibility that two or more devices will try and use the same MTS and their transmissions will collide. These MTS assigned to allow contention can be called contention MTS (CMTS). Some CMTS can be assigned to an “unassigned” association ID (e.g., defined as OXFE in the IEEE 802.15.3 standard). These CMTS are sometimes called association MTS, since they are used for new devices requesting association. In addition, the coordinator 310 can also assign CMTS for any devices already associated with the network 310. These CMTS are preferably assigned the broadcast association ID (e.g., defined as OXFF in the IEEE 802.15.3 standard). These CMTS are sometimes called open MTS, and they can be used for devices that only rarely need an MTS, such as devices in a deep sleep mode.

In alternate embodiments deep-sleeping devices may sacrifice their assigned MTS while in a power-saving deep sleep mode. When such deep-sleeping devices wish to rejoin the network in a waking status, they must do so in contention, e.g., as if they were newly joining the network, since they have no assigned MTS.

Request Sent Without Contention

In the preferred embodiment, all requests except association requests and requests by deep sleeping devices 320 to rejoin the network 300 are performed without contention. As shown above with respect to FIG. 6, MTS can be assigned to individual non-coordinator devices 320 to allow them an uncontended time slot in which to communicate with the coordinator 310.

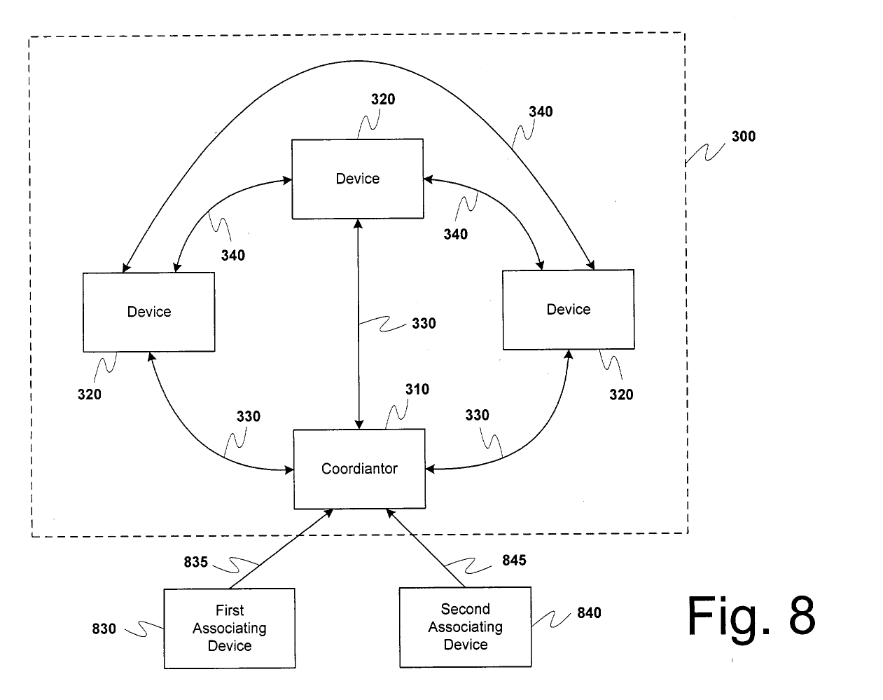

FIG. 7 is a message sequence chart showing a request and synchronization process performed between a non-coordinating device 320 and a coordinator 310, without contention according to a preferred embodiment of the present invention. In this request and synchronization process, a non-coordinator device 320 issues a request and a coordinator 310 replies to that request. This process offers a good means of providing state synchronization between the requesting non-coordinator device 320 and the coordinator 310.

As shown in FIG. 7, the non-coordinator device 320 begins by sending a request 710 to the coordinator 310. This request 710 preferably includes all properties and values of a service or resource that the requesting device 320 is asking the coordinator 310 to allocate or perform. For example, a channel time request would need to include the amount of channel time needed. The request 710 can have its acknowledgement policy set to either require acknowledgement or not, as desired.

Assuming that the coordinator 310 receives the request 710 properly, it will send a response 720 to the non-coordinating device 320 that includes everything the requesting device 320 needs to know to correctly use a new allocated or changed resource, or any needed property and resulting values or status of a service that was requested.

Preferably the response 720 will be sent as a directed frame, i.e., addressed specifically to the requesting non-coordinator device 320, so that the non-coordinator device 320 can send an acknowledgement (ACK) 730 to the coordinator 310 in response to the response 720. This ACK 730 is important, since only by receiving the ACK 730 can the coordinator 310 be certain that the non-coordinator device 320 received the response 720.

Once the coordinator 310 has received the ACK 730 from the non-coordinator device 320, the request process is complete. However, to achieve greater synchronization between the coordinator 310 and the non-coordinator device 320, the coordinator 310 should then send a result indicator to the non-coordinator device 320 to indicate that the ACK was received. Otherwise the requesting non-coordinator device 320 will have no way of knowing whether its ACK 730 successfully reached the coordinator 310.

The reason this is important is that request process is not complete until the coordinator 310 successfully receives the ACK 730. In fact, the coordinator 310 will fail the request 710 if its response 720 is not acknowledged. Thus, the non-coordinator device 320 may get the response 720, but until it knows that the coordinator 310 received the ACK 730 resulting from that response 720, it can't be certain that the request process is successful.

Therefore, upon receiving the ACK 730 and completing the request process, the coordinator will preferably update the beacon to indicate this fact. (Process step 740). Thus, when the next beacon 750 is sent, it includes beacon parameters that indicate the success of the request process, allowing the non-coordinator device 320 to know the success of the request process with no ambiguity. The beacon parameters preferably include at least the identifier of the requesting non-coordinator device 320 and some minimal information to confirm that the requested resource is ready for use.

After the non-coordinator device 320 receives the beacon 750, the coordinator 310 and the non-coordinator device 320 are successfully synchronized. (Process step 760)

The reason that the acknowledgement of the request 710 is optional as far as synchronization is concerned is that the coordinator 310 and the non-coordinator device 320 have an alternate way of synchronizing when the request 710 is not properly received. After sending the request 710, the management entity 440 of the non-coordinator device 320 will wait for the response 720. If the response 720 doesn't come within a set amount of time, the management entity 440 will assume the request 710 has failed. Then, if the current protocol allows, the request 710 may later be repeated.

Regardless, after the assumed failure of the request process, both the coordinator 310 and the non-coordinator device 320 are in the same state. The coordinator 310 never received the request, and the non-coordinator device 320 assumes that its request never arrived. Therefore the two do not need to be synchronized.

Request Sent Under Contention

In a preferred embodiment, only association requests (and requests by deep sleeping devices 320 to rejoin the network 300, if a deep sleep mode is implemented) are performed under contention. Alternate embodiments could allow other requests to be performed in contention, however.

FIG. 8 is a block diagram showing two new associating devices trying to associate with an existing wireless network, according to a preferred embodiment of the present invention. As shown in FIG. 8, an existing network 300 includes a coordinator 310 and a plurality of non-coordinator devices 320. First and second associating devices 830 and 840 are not connected to the existing network 300, but desire to associate with it.

In order to be capable of joining the existing network 300, both the first and second associating devices 830 and 840 must be able to hear the coordinator 310 and be heard by the coordinator 310. In addition, both must be able to recognize the superframe structure that the network 300 is using. Each will listen to a number of superframes until it detects a suitable time slot for association (e.g., an unassigned MTS) and will then send an association frame to the coordinator 310 to try and associate with the network 300.

If each associating device 830, 840 chooses a different unassigned MTS to send its association frame, then there will be no contention and the two association requests will be processed properly. However, if they send their association requests during the same unassigned MTS, there will be contention. In this case there are two main possible results: either the two association requests will have a similar signal strength (e.g., the two associating devices 830 and 840 are roughly the same distance away from the coordinator 310), or one association request will have a significantly higher signal strength than the other (e.g., the first associating device 830 is closer to the coordinator 310 than is the second associating device 840).

If the two association requests 835 and 845 are sent in the same unassigned MTS and have equal signal strengths, then they will interfere with each other and the coordinator 310 will be able to read neither. A cyclic redundancy check (CRC) on the incoming association requests will fail (since the requests overlap) and the coordinator will not response to either request 835, 845.

As a result, both the first and the second associating devices 830 and 840 will each have to send another association request 835, 845. Preferably a certain amount of randomness is introduced into their respective retry back-off times to avoid future collisions. Otherwise the two would likely collide again at the next available MTS and so on, colliding forever and never associating with the network. This can be accomplished by simply having each associating device 830, 840 wait a random amount of time before sending a new association request.

However, signal strengths are not always similar. In some situations the signal strength of one device (say, the first associating device 830) will be significantly stronger than that of the other device (say, the second associating device 840) Although both may be strong enough for the coordinator 310 to read if they were the only signals being transmitted, the signal strength of the first association request 835 may be strong enough to drown out the second association signal 845.

In this case the first association request 835 from the first associating device 830 will be processed and the first new device will become associated with the network 300. There will be no contention since the coordinator 310 only ever heard the first association request 835 and never heard the second association request 845 from the second associating device 840. However, there must be some way for a given associating device 830, 840 to determine whether a response message is intended for it or a contending device. Otherwise when the coordinator 310 replied to the first association request 835, the first and second associating devices 830 and 840 (who can both hear the coordinator 310) might consider it to be directed at them (after all, they both just send out an association request).

One way to accomplish this is to use the 48-bit MAC addresses of the associating device 830 and 840 as unique identifiers for a request and synchronization process.

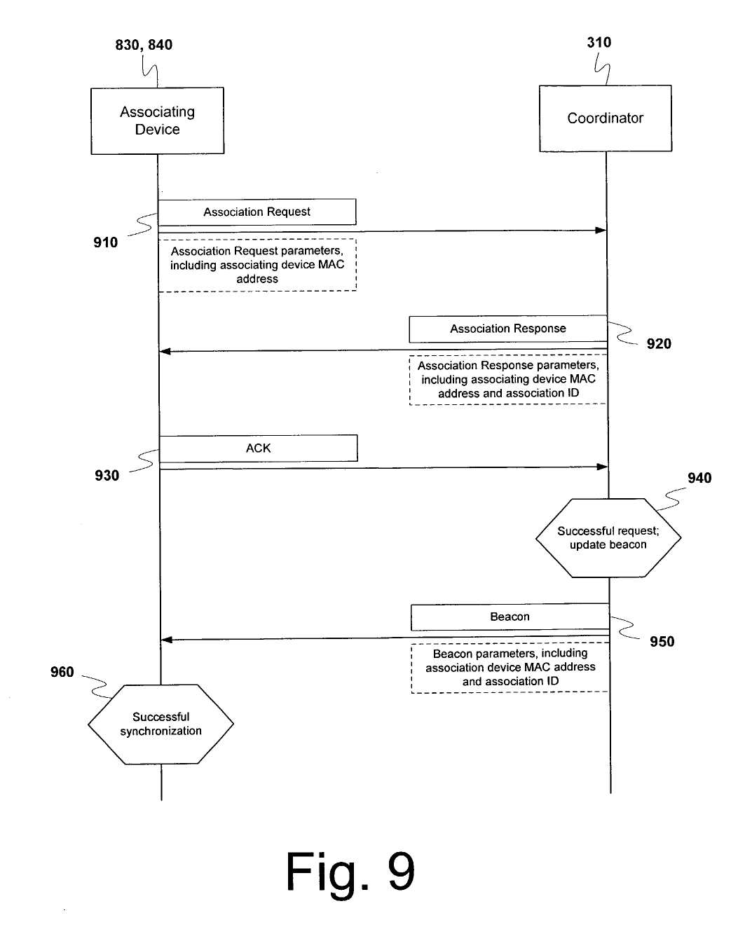

FIG. 9 is a message sequence chart showing a request and synchronization process performed between an associating device 830, 840 and a coordinator 310, with contention according to a first preferred embodiment of the present invention. In this request and synchronization process, an associating device 830, 840 issues a request and a coordinator 310 replies to that request. This process offers a good means of providing state synchronization between the associating device 830, 840 and the coordinator 310.

As shown in FIG. 9, the associating device 830, 840 begins by sending an association request 910 to the coordinator 310. This association request 910 includes all information about the associating device 830, 840 that the coordinator 310 and possibly other non-coordinator devices 320 need to know to correctly interact with the associating device 830, 840 in the network 300. This can include the MAC address of the associating device 830, 840. As with the uncontested request and synchronization process 700, the association request 910 and can have its acknowledgement policy set to either require acknowledgement or not, as desired.

Assuming that the coordinator 310 receives the association request 910 properly, it will send an association response 920 to the associating device 830, 840 that includes a set of association response parameters, including everything the associating device 830, 840 needs to know about the coordinator 310 and the network configuration to correctly interact with the coordinator 310 and all other non-coordinator devices 320 in the network. This can include the unique identifier passed in the association request 910 by the associating device 830, 840 that made the association request 910, and the new association ID that is assigned to the associating device 830, 840.

As shown in FIG. 8, it's possible that more than one associating device 830, 840 will try to associate with the network 300 at the same time. If the coordinator 310 responds to one of the requesting new devices (say the first associating device 830), then it's necessary that the association response 920 contain a unique identifier to the first associating device 830. This will allow the first associating device 830 and the second associating device 840 (and any other conflicting associating devices) to determine whom the association response 920 was intended for. Preferably the 48-bit MAC address for the successful device will serve as this unique identifier.

Thus, even if several new associating devices sent an association request at the same time, they will each be able to read the unique identifier (48-bit MAC address) in the association response 920 and determine of the response is intended for them. Thus, only the intended recipient will act on the association response 920.

The response 920 will preferably be sent as a directed frame, i.e., addressed to the successful associating device 830, 840 by its unique identifier (e.g. its MAC address), so that the successful associating device 830, 840 it is directed at can send an acknowledgement (ACK) 930 to the coordinator 310 in response to the association response 920. This ACK 930 is important, since only by receiving the ACK 930 can the coordinator 310 be certain that the successful associating device 830, 840 received the association response 920.

Once the coordinator 310 has received the ACK 930 from the successful associating device 830, 840, the association request process is complete. However, to achieve greater synchronization between the coordinator 310 and the successful associating device 830, 840, the coordinator 310 should then send a result indicator to the successful associating device 830, 840 to indicate that the ACK 930 was received. Otherwise the requesting associating device 830, 840 will have no way of knowing whether its ACK 730 successfully reached the coordinator 310.

The reason this is important is that request process is not complete until the coordinator 310 successfully receives the ACK 930. In fact, the coordinator 310 will fail the association request 910 if its association response 920 is not acknowledged. Thus, the associating device 830, 840 may get the association response 920, but until it knows that the coordinator 310 received the ACK 930 resulting from that association response 920, it can't be certain that the request process is successful.

Therefore, upon receiving the ACK 930 and completing the association request process, the coordinator 310 will preferably update the beacon to indicate this fact. (Process step 940). Thus, when the next beacon 950 is sent, it includes beacon parameters that indicate the success of the request process, as well as the MAC address and association ID. This allows the non-coordinator device 320 to know the success of the request process with no ambiguity.

The purpose of the information in the beacon 950 is to confirm that the coordinator 310 received the ACK 930 of the association response 920. From the standpoint of the newly associated device, it's only necessary to send an information element with its new association ID, since the newly associated device has received the association response 920 associating its MAC address with this new association ID. The MAC address is still contained in the beacon 950 is to inform any other requesting new devices about the new association. In some embodiments other devices may opt to listen to such announcements to build their address resolution tables. However, this is not required.

In some embodiments the beacon including the association information can be the next beacon following the ACK 930. In other embodiments the beacon 950 containing the association information can be a later beacon.

After the non-coordinator device 320 receives the beacon 950, the coordinator 310 and the associating device 830, 840 are successfully synchronized. (Process step 960)

Problems in a Contention Environment

Contention operations can cause some additional problems. Some of these problems involve the Near/Far problem, and result from the fact that the coordinator 310 may respond to one of the requests and not another. Such problems are not generally seen in equal strength contentions, since they often result in garbled communications from all requesting devices. In such situations, the coordinator 310 will not respond to any associating devices 830, 840.

The problems discussed below each involve two new devices 830 and 840. When the Near/Far problem is involved, the first associating device 830 will be considered a near device and the second associating device 840 will be considered a far device. However, their roles could easily be reversed.

In addition, multiple new devices could be present, each having a varying distance to the coordinator 310. In such an embodiments, to the extent that signals from one new device are received at the coordinator 310 with sufficiently higher signal strength compared to signals from the other new devices, the Near/Far problems below may apply. If the signal strengths are too close, they will interfere, requiring retransmission of any requests.

As shown below, the preferred embodiment described above addresses each problem and provides acceptable resolutions to the problems that may arise.

One problem can occur when both the near associating device 830 and the far associating device 840 both hear the association response 920. The association response 920 (intended for the near associating device 830) is sent to a special unassigned association ID that is set aside for newly-associating devices, and has its ACK policy set to require acknowledgement. If both the near and far associating devices 830 and 840 hear the association response 920, they could both try and send the ACK 930.

The problem occurs because generally an ACK is performed at the MAC layer 820 of a device before the incoming signal is processed sufficiently to read its parameters and determine if the incoming response frame was a response to it s own request or a request from another device.

Generally this will not be a problem since this situation assumes that a Near/Far problem existed at the time of the association requests with respect to the near associating device 830 and the far associating device 840. Thus, all other things remaining the same, when it comes time for the ACK 930, the Near/Far problem will still exist and the coordinator 310 will only get an ACK 930 from the near associating device 830. The ACK 930 has the same range as the original association request 910 and suffers equally from the Near/Far problem. Thus, the coordinator 310 can process that ACK 930 and send a new beacon 950 appropriately. The coordinator 310, near associating device 830, and far associating device 840 will all be in agreement that the near associating device 830 was successfully associated and the far associating device 840 was not.

However, if only one association request 910 reached the coordinator 310 due to temporary signal distortions (making it appear as if there is a Near/Far situation), but at the time to send acknowledgement, both devices have the same signal strength at the coordinator 310, both will send and ACK 930 and the ACKs will interfere and be garbled (e.g., through a failed header check sequence). As a result, neither associating device 830, 840 will be announced in a following beacon and the coordinator 310, the near associating device 830, and the far associating device 840 will regard the association attempt as failed. Although this is unfortunate in that both associating devices 830, 840 will be delayed in their association with the network, it is resolved from a synchronization standpoint because all of the devices agree about what state they are in.

In the alternative, consider if due to temporary signal distortions an association request 910 reaches the coordinator 310 from the far associating device 840 and not from the near associating device 830. If both the near and far associating devices 830 and 840 receive the association response 920, both will send an ACK 930. But if at the time to send acknowledgement, the near associating device 830 is received stronger at the coordinator 810 than the far associating device 840, the coordinator 310 will receive the ACK 930 from the near associating device 830, but not hear the ACK from the far associating device 940.

In this case the coordinator 310 will process the ACK 930 regardless of who sent it. Since all associating devices 830, 840 at this point use the unassigned association ID it doesn't matter who sent it. The coordinator 310 will accept the ACK from any associating device 830, 840.

However, once the MAC layer 420 in each associating device 830, 840 processes the association response, the near associating device 830 will determine that its association request was not acted on, and the far associating device 840 will determine that its association request was acted on. The coordinator 310 will send out a new beacon 950 that will confirm this. Thus, the coordinator 310, the near associating device 830, and the far associating device 840 will be in agreement that the far associating device 840 was successfully associated and the near associating device 830 was not.

If for some reason the far associating device 840 never receives the response 920, but the near associating device 830 acknowledges the response 920, the far associating device 840 will simply repeat the association request 910 again. When the coordinator 310 hears the new association request, it will follow the process set forth in FIG. 9, sending an association response 920 to the far associating device 840, providing the same response information from the first association response.

Another problem can occur when a second associating device 840 sends an association request 910 in a CMTS after a first associating device 830 has sent its association request but before the coordinator 310 has sent its association response. Both the first and second associating devices 830 and 840 will now be waiting for an association response 920, and both associating devices 830, 840 will be listening to the unassigned association ID. As a result, both will hear the association response 920, and both will send out an ACK 930.

If both associating devices 830 and 840 send an ACK 930 and both are at the same distance from the coordinator 301, the ACK 930 will be garbled and neither will become associated.

Not receiving a valid ACK 930, the coordinator 310 will never make a beacon announcement 950 confirming receipt of the ACK 930 and will consider the association attempt a failure. Not receiving a beacon announcement confirming receipt of the ACK 930, the first associating device 830 (i.e., the proper recipient of the association response 920) will assume its association request was a failure. And having processed the association response 920, the second associating device 840 will know that its association request was a failure. The coordinator 310, the first associating device 830, and the second associating device 840 will all be in agreement that the association attempts failed. Although this is unfortunate in that both associating devices 830, 840 will be delayed in their association with the network, it is resolved from a synchronization standpoint because all of the devices agree about what state they are in.

But if at the time to send acknowledgement, the only one associating device (830 or 840) is received stronger at the coordinator 810 than the other device, the coordinator 310 will receive that ACK 930 and process it accordingly. As noted above, since all associating devices 830, 840 at this point use the unassigned association ID it doesn't matter who sent it. The coordinator 310 will accept the ACK from any associating device 830, 840.

Thus, once the MAC layer 420 in each associating device 830, 840 processes the association response, the first associating device 830 will determine that its association request was acted on, and the second associating device 840 will determine that its association request was not acted on. The coordinator 310 will then send out a new beacon 950 that will confirm this. Thus, the coordinator 310, the first associating device 830, and the second associating device 840 will be in agreement that the first associating device 830 was successfully associated and the second associating device 940 was not.

If for some reason the first associating device 830 never receives the response 920, but the second associating device 840 acknowledges the response 920, the first associating device 830 will simply repeat the association request 910 again. When the coordinator 310 hears the new association request 910, it will follow the process set forth in FIG. 9, sending an association response 920 to the first new device 930, providing the same response information from the first association response.

In addition, since only one beacon 950 is sent with the new association information included, there is a possibility that one of the associating devices 830, 840 will miss that beacon 950 and regard the association procedure as failed, even though the coordinator 310 regards it as successful.

If an associating device 830, 840 misses the beacon 950 with the association announcement, it may retry the association by sending a new association request 910. In this case the coordinator 310 should determine that the same MAC address already has an association ID and process the association request 910 by sending out an association response just as if it were a new request. In this case, however, the coordinator simply passes on the information that it already has for the association of the associating device 830, 840.

If the associating device 830, 840 misses the beacon 950 and does not retry the association request, then normal garbage collection routines (e.g., association timeout period) in the coordinator 310 will preferably automatically disassociate this device after a time.

Alternate Embodiment

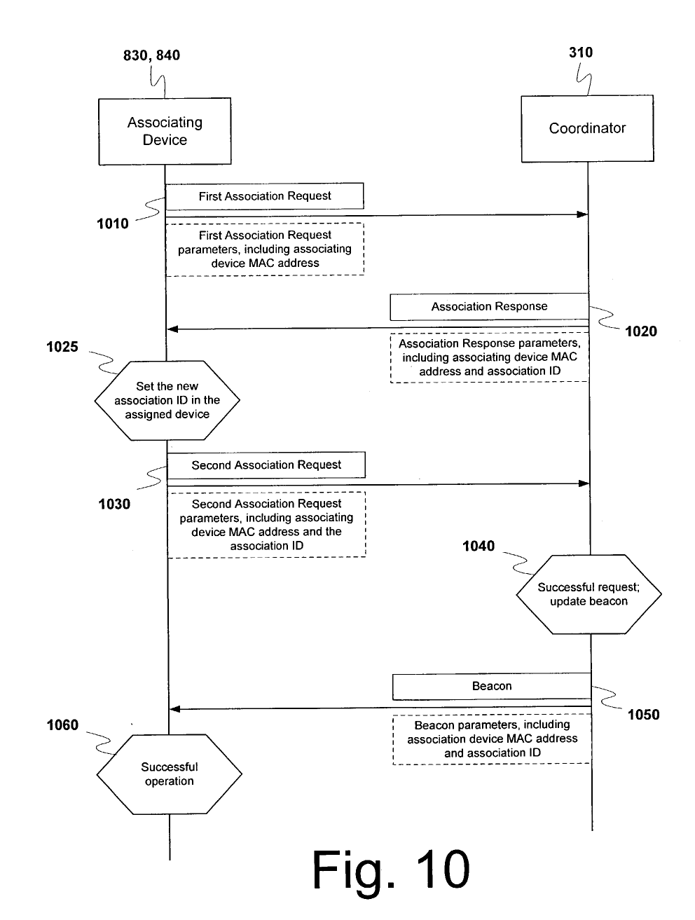

FIG. 10 is a message sequence chart showing a request and synchronization process performed between an associating device 830, 840 and a coordinator 310, with contention according to a second preferred embodiment of the present invention. In this request and synchronization process, an associating device 830, 840 issues a request and a coordinator 310 replies to that request. This process offers a good means of providing state synchronization between the requesting associating device 830, 840 and the coordinator 310.

As shown in FIG. 10, the associating device 830, 840 begins by sending a first association request 1010 to the coordinator 310. This first association request 1010 includes all information about the associating device 830, 840 that the coordinator 310 and possibly other non-coordinator devices 320 need to know to correctly interact with the associating device 830, 840 in the network 300. This can include the MAC address of the associating device 830, 840. As with the uncontested request and synchronization process 700, the first association request 1010 can have its acknowledgement policy set to either require acknowledgement or not, as desired.

Assuming that the coordinator 310 receives the first association request 1010 properly, it will send an association response 1020 to the associating device 830, 840 that includes a set of association response parameters, including everything the associating device 830, 840 needs to know about the coordinator 310 and the network configuration to correctly interact with the coordinator 310 and all other non-coordinator devices 320 in the network. This preferably includes the unique identifier passed in the first association request 1010 by the associating device 830, 840 that made the association request 1010, and the new association ID that is assigned to the associating device 830, 840.

As shown in FIG. 8, it's possible that more than one associating device 830, 840 will try to associate with the network 300 at the same time. If the coordinator 310 responds to one of the requesting new devices (say the first associating device 830), then it's necessary that the association response 1020 contain a unique identifier to the first new device 830. This will allow the first associating device 830 and the second associating device 840 to determine whom the association response 1020 was intended for. Preferably the 48-bit MAC address for the successful associating device 830, 840 will serve as this unique identifier.

Thus, even if several associating devices sent an association request at the same time, they will each be able to read the unique identifier (48-bit MAC address) in the association response 1020 and determine of the response is intended for them. Thus, only the intended recipient will act upon the association response 1020.

In this embodiment the association response 1020 is preferably sent with the acknowledgement policy set to require no acknowledgement.

Based on the response 1020, the successful associating device 830, 840 will then set its association ID to be the association ID sent in the response 1020. (Process step 1025)

The successful associating device 830, 840 will then send a second association request 1030 to the coordinator 310. This second association request 1030 will include all of the information from the first association request 1010, but will use the newly-assigned association ID as a source address rather than the unassigned address reserved for newly-associating devices.

This second association request 1030 will act as the confirmation to the coordinator 310 that the intended associating device 830, 840 received the response 1020. However, since only the intended associating device 830, 840 will send the second association request 1030, there can be no conflict with this association request 1030.

Therefore, upon receiving the second association request 1030 and completing the association request process, the coordinator 310 will preferably update the beacon to indicate this fact. (Process step 1040). Thus, when the next beacon 1050 is sent, it includes beacon parameters that indicate the success of the request process, as well as the MAC address and association ID of the successful associating device 830, 840. (Process Step 1050) This allows the non-coordinator device 320 to know the success of the request process with no ambiguity.

The purpose of the information in the beacon 1050 is to confirm that the coordinator 310 received the second association request 1030 of the successful associating device 830, 840. The MAC address is preferably still contained in the beacon 1050 to inform any failing associating devices about the new association. In some embodiments other devices may opt to listen to such announcements to build their address resolution tables. However, this is not required.

In some embodiments the beacon including the association information can be the next beacon following the second association request 1030. In other embodiments the beacon 1050 containing the association information can be a later beacon. After the non-coordinator device 320 receives the beacon 1050, the coordinator 310 and the successful associating device 830, 840 are successfully synchronized. (Process step 1060)

Other Applications

The process shown in FIG. 7 may also be useful in other circumstances during operation of a wireless network.

The request-response-ACK-beacon sequence is useful for all synchronous requests (e.g., a remote procedure call format). For example, in the case of a channel time allocation (CTA) request for a stream, the coordinator 310 will only allocate the CTA if it gets an acknowledgement for its CTA response frame. Similarly, the CTA requester will only regard the CTA request as successful if it receives a beacon indicating the allocated CTA.

There is no contention for CT request frames, so the destination address of the response frame is always unique. Therefore, these transmissions are always done without contention.

However, a problem may occur if the CT requester misses the beacon indicating the CTA within a set timeout period. In this case, the CT requestor may retry the request, and the coordinator 310 may not know if the request is a new request or a repetition of an old request.

One way to solve this problem is to add a request identification number to the CT request. The requesting device preferably assigns this request ID locally, and the coordinator 310 stores the request ID for every CT request it has approved. When a new request is received, the coordinator 310 compares the new request ID against previous requests to see whether it is a new request or a repeated request.

Asynchronous Requests

Asynchronous requests are different from isochronous requests. With an isochronous request, the requestor is looking to change the state of both the requestor and the coordinator 310 and to find a stream in which to transmit. In comparison, an asynchronous request is only a one-time thing, and so does not need to change states. It is concerned only with sending a particular set of data and does not need that repeated absent another request.

As a result, an isochronous request requires that both the coordinator 310 and the requesting non-coordinator device 320 are synchronized in state before they can proceed with the requested transmissions. Thus, an isochronous request will preferably timeout during setup if it is not properly completed within a set time.

However, an asynchronous request is not so stringent. All the requester of an asynchronous request needs is to know if the coordinator 310 received the request. After that, the requesting non-coordinator device 320 will wait for the coordinator 310 to respond to that request, and will timeout if the request is not met within a set time.

For example, with an asynchronous CTA request, the request will either be granted or the data in the requesting device will be timed out and its transmission regarded as a failure. In this case there is no state change in the requesting device, so there is no requirement that the client waits for completion of the request transaction before starting the operation. Rather, it already has a queued asynchronous operation and is waiting for the go-ahead signal to execute it.

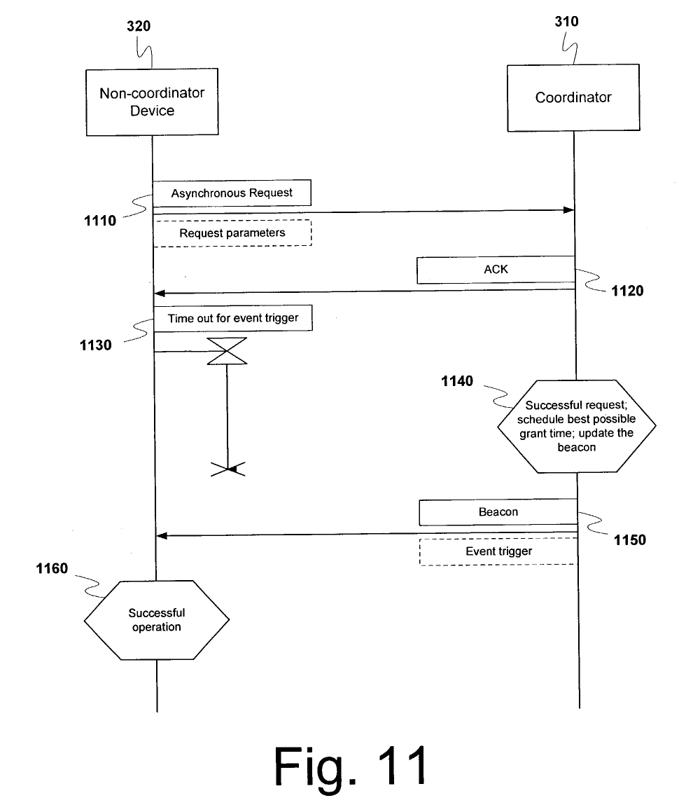

FIG. 11 is a message sequence chart showing a typical asynchronous request between a non-coordinating device 320 and a coordinator 310, according to a preferred embodiment of the present invention. In this request process, a non-coordinator device 320 issues a request and a coordinator 310 replies to that request.

As shown in FIG. 11, the non-coordinator device 320 begins by sending an asynchronous request 1110 to the coordinator 310. This asynchronous request 1110 includes all of the parameters needed for the coordinator 310 to allocate the requested resources at a time when there is enough availability, and can have its acknowledgement policy set to require acknowledgement.

Assuming that the coordinator 310 receives the asynchronous request 1110 properly, it will send an ACK 1120 to the non-coordinating device 320.

Once it sends its ACK 1120 the non-coordinating device 320 will begin to wait for a set timeout period waiting for a particular event trigger 1130, e.g., a CTA in a beacon in response to an asynchronous CT request. In some cases the fulfillment of the request may be spread out over time, e.g., channel time being allocated in smaller portions over a number of superframes until a requested channel time is granted.

Once the coordinator 310 has received the ACK 1120 from the non-coordinator device 320, the request process is complete. The coordinator 310 should then schedule the best possible grant time it can in response to the asynchronous request 1110 and send an event trigger in a later beacon to indicate that the requested resources or services (or at least a portion of them) is available. (Process step 1140)

Thus, when the next (or later) beacon 1150 is sent, it includes an event trigger that indicates the success of the request process, allowing the non-coordinator device 320 to know the success of the request process with no ambiguity.

After everything requested has been delivered, as indicated in one or more beacons, the coordinator 310 and the non-coordinator device 320 have successfully completed the asynchronous request operation. (Process step 760)

The request-response-ACK-beacon sequence and the request-response-request-beacon sequences are preferably used when a synchronized state must be reached between coordinator 310 another device before any further activity can be taken. The initial request may be approved or denied, and all devices involved should agree on whether the request was approved or denied.

The request-ACK-beacon sequence is used when the coordinator 310 should continuously offer a service to a particular device until the service is either used or the device revokes the request. All exceptions to this are preferably are handled by timeouts. A low-level acknowledgement/retry utility can be used to make sure the coordinator 310 gets the request. Once the coordinator 310 has received the request, the confirming allotment is guaranteed to come sooner or later.

Obviously, numerous modifications and variations of the present invention are possible in light of the above teachings. For example, although all contended requests were shown by way of an association request example, other contended requests could be used. It is therefore to be understood that within the scope of the appended claims, the invention may be practiced otherwise than as specifically described herein.

We claim:

1. A method for synchronizing a network coordinator with a remote device in a wireless network, comprising:
sending a request from the remote device to the network coordinator, the request including request parameters;
sending a reply from the network coordinator to the remote device, the reply including reply parameters that respond to the request parameters;
sending an acknowledgement from the remote device to the network coordinator, the acknowledgement indicating successful receipt of the reply; and
sending a beacon from the network coordinator to the remote device, the beacon including beacon parameters, the beacon parameters including at least a portion of the reply parameters.

2. A method for synchronizing a network coordinator with a remote device in a wireless network, as recited in claim 1, wherein the request is an association request.

3. A method for synchronizing a network coordinator with a remote device in a wireless network, as recited in claim 1, wherein the request parameters include a device identifier for the remote device, the device identifier distinguishing the network device from other devices.

4. A method for synchronizing a network coordinator with a remote device in a wireless network, as recited in claim 3, wherein the device identifier is a multiple-bit address assigned by a manufacturer to the remote device, which is unique among similar devices.

5. A method for synchronizing a network coordinator with a remote device in a wireless network, as recited in claim 3, wherein the reply parameters include the device identifier for the remote device and a network identifier for the remote device, the network identifier being assigned by the network coordinator to distinguish the remote device from other network devices.

6. A method for synchronizing a network coordinator with a remote device in a wireless network, as recited in claim 5, wherein the network identifier is a multiple-bit association identifier that is unique within the network.

7. A method for synchronizing a network coordinator with a remote device in a wireless network, as recited in claim 5, wherein the network identifier is smaller in size than the device identifier.

8. A method for synchronizing a network coordinator with a remote device in a wireless network, as recited in claim 5, wherein the beacon parameters include the device identifier for the remote device and the network identifier for the remote device.

9. A method for synchronizing a network coordinator with a remote device in a wireless network, comprising:
sending a first request from the remote device to the network coordinator, the first request including first request parameters;
sending a reply from the network coordinator to the remote device, the reply including reply parameters that respond to the request parameters;
sending a second request from the remote device to the network coordinator, the second request including second request parameters, the second request parameters including at least part of the reply parameters; and
sending a beacon from the network coordinator to the remote device, the beacon including beacon parameters, the beacon parameters including at least a portion of the reply parameters.

10. A method for synchronizing a network coordinator with a remote device in a wireless network, as recited in claim 9, wherein the first and second requests are association requests.

11. A method for synchronizing a network coordinator with a remote device in a wireless network, as recited in claim 9, wherein the first request parameters include a device identifier for the remote device, the device identifier distinguishing the network device from other devices.

12. A method for synchronizing a network coordinator with a remote device in a wireless network, as recited in claim 11, wherein the device identifier is a multiple-bit address assigned by a manufacturer to the remote device, which is unique among similar devices.

13. A method for synchronizing a network coordinator with a remote device in a wireless network, as recited in claim 11, wherein the reply parameters include the device identifier for the remote device and a network identifier for the remote device, the network identifier being assigned by the network coordinator to distinguish the remote device from other network devices.

14. A method for synchronizing a network coordinator with a remote device in a wireless network, as recited in claim 13, wherein the network identifier is a multiple-bit association identifier that is unique within the network.

15. A method for synchronizing a network coordinator with a remote device in a wireless network, as recited in claim 13, wherein the second request parameters include at least the device identifier for the remote device.

16. A method for synchronizing a network coordinator with a remote device in a wireless network, as recited in claim 15, wherein the second request parameters include at least the network identifier for the remote device.

17. A method for synchronizing a network coordinator with a remote device in a wireless network, as recited in claim 13, wherein the network identifier is smaller in size than the device identifier.

18. A method for synchronizing a network coordinator with a remote device in a wireless network, as recited in claim 13, wherein the beacon parameters include the device identifier for the remote device and the network identifier for the remote device.
